(19) United States
(12) Patent Application Publication
(10) Pub. No.: US 2008/0258568 A1
(43) Pub. Date: Oct. 23, 2008

(54) Electrical Linear Drive Device

(75) Inventors: Matthias Finkbeiner, Motzingen (DE); Jurgen Guckel, Filderstadt (DE); Hava Yigit, Ebersbach (DE)

Correspondence Address: HOFFMANN & BARON, LLP, 6900 JERICHO TURNPIKE, SYOSSET, NY, 11791, US

(73) Assignee: FESTO AG & CO, Esslingen (DE)

(21) Appl. No.: 12/099,283

(22) Filed: Apr. 8, 2008

(30) Foreign Application Priority Data
Apr. 11, 2007 (DE) 10 2007 017 968.7

(51) Int. Cl. H02K 41/02

(52) U.S. Cl. 310/12

(57) ABSTRACT

An electrical linear drive device with an electric linear motor held in a base housing is proposed that has a long-coil system arranged in a motor housing, and a substantially shorter armature that drives a drive element linearly via a drive rod extending to the outside. Two guide rods running in base housing, and a position measuring rod cooperating with at least one position sensor for position detection that plunges, depending on its position, into base housing are connected to drive element.

### CROSS-REFERENCE TO RELATED APPLICATION

This application claims priority based on German Application No. 10 2007 017 968.7 filed on Apr. 11, 2007, which is incorporated herein by reference.

### BACKGROUND OF THE INVENTION

1. Field of the Invention

The invention pertains to an electrical linear drive device as is known, for instance, from EP 1150416 A1, DE 10244261 A1 or DE 29705315 U.

2. Brief Description of the Related Art

To control or regulate the linear motion or travel to desired positions, it is fundamentally necessary to have a position detection system for this purpose. An integrated positioning system is known, for instance, from the aforementioned DE 29705315 U, in which the currents are evaluated by the measurement coils for position detection. This system is not suitable for higher measurement precision requirements. An external position measuring system in which a position measuring rod running parallel to the linear motor interacts with the sensor is known from EP 1150416 A1. The known linear motor has a magnet system advancing out of a housing, whereby there is the danger that the measurement results for position determination may be falsified or impaired.

One problem of the present invention is to create a very precisely operating electrical linear drive device with a very exact position measuring device that is impaired as little as possible by magnetic influences.

### SUMMARY OF THE INVENTION

This problem is solved according to the invention by an electrical linear drive device.

A very exact linear motion is guaranteed by at least two guide rods running in the base housing of the linear drive device. The armature having a permanent magnet arrangement runs inside a motor housing serving as a magnetic return member and having a long-coil system, so that the external position measurement system having a position measurement rod is largely unaffected by interfering magnetic influences that could impair the position measuring precision.

Advantageous refinements and improvements of the linear drive device specified herein are enabled by means of the measures specified herein.

The cross section of one of the drive rods is advantageously less than half the cross section of one of the guide rods, preferably less than 25% of the cross section of one of the guide rods. The drive rod thereby forms a type of solid-body [flexure] joint, and does not require an articulated bearing in the drive element due to its small cross section. Particularly with two guide rods, a very precise linear guidance is achieved, especially if they are arranged symmetrically on both sides of the drive rod.

Ball bush guides are preferably provided for precise guidance of the guide rods in the base housing.

At least one position sensor preferably serves for sensing position determination markers on the position measuring rod, and is arranged on the base housing in the vicinity of the position measuring rod in order to interact with it. Magnetic markers for magnetic position detection are advantageously provided.

In an advantageous configuration of the position measuring device, a plurality of digital counting markers is provided along the position measuring rod, and/or at least one position marker for detecting at least one reference position is provided. A particularly exact position detection is achieved because the counting markers are counted up or down, depending on the movement direction, in an electric counting unit starting from the detected reference position.

A position sensor for detecting the counting markers and/or at least one position sensor for detecting at least one position marker is preferably provided, both position sensors being expediently provided and arranged on either side of the plunge channel for the position measuring rod.

An internal channel and/or a groove-like channel open to the exterior advantageously serves to accommodate the position sensors in the base housing.

The base housing advantageously possesses internal cable channels for accommodating the sensor lines and/or supply and control lines for the linear motor, so that the base housing serves as a shield, and external laying of cables is avoided. The sensor lines can run on one side, and the supply or control lines on the other, in separate cable channels for mutual shielding. The cable channels and, thus, the lines preferably open into a connection point for an external line.

### BRIEF DESCRIPTION OF THE DRAWINGS

An embodiment of the invention is represented in the drawing and will be explained in the description below. Therein:

FIG. 1 shows, as an embodiment of the invention, an oblique representation of an electrical linear drive device with extended drive rod;

FIG. 2, an enlarged representation of a point, marked by a circle in FIG. 1, at which the position sensor is arranged in a groove-like channel open to the exterior;

FIG. 3, a view of the base housing from an end face; and

FIG. 4, a horizontal sectional representation of the linear drive device along section line A-A in FIG. 3.

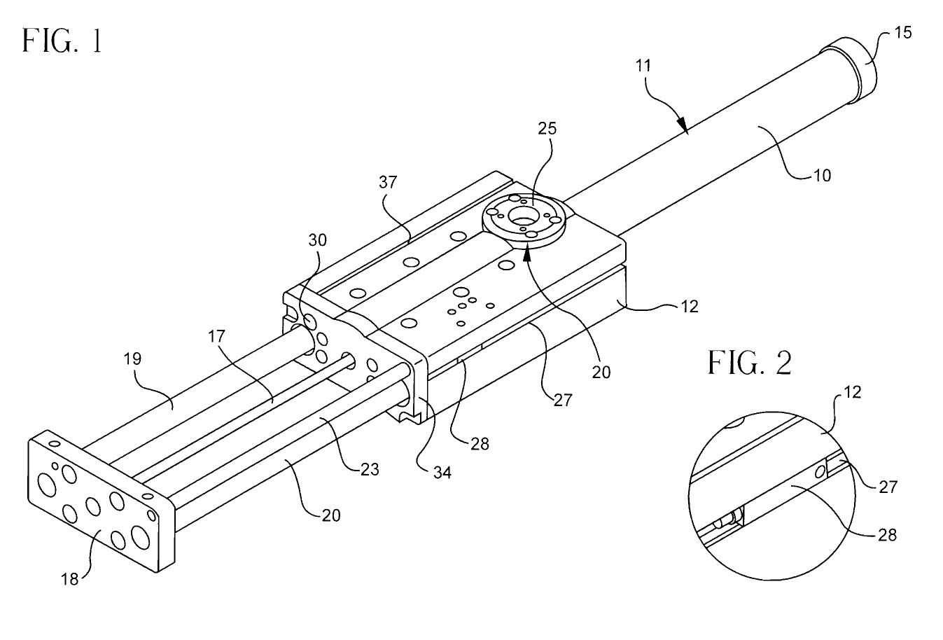

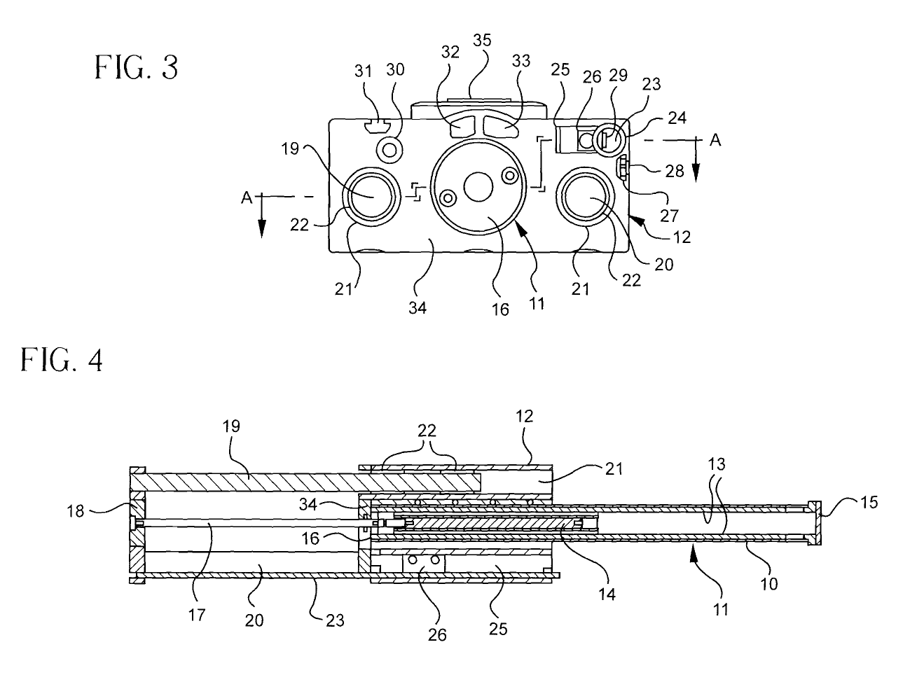

### DETAILED DESCRIPTION OF THE PREFERRED EMBODIMENTS

In the represented embodiments for an electrical linear drive device, a tubular elongated motor housing 10 for linear motor 11 is fixed in a flat rectangular base housing 12. Motor housing 10 here extends in a corresponding accommodation channel through base housing 12 and protrudes from the latter at one end. Motor housing 10 has a circular or annular cross section.

A long-coil system 13 as the drive coil arrangement runs on the inside of motor housing 10 substantially along the entire motor housing 10. An armature 14 having a permanent magnet arrangement consisting of several permanent magnets is movably guided inside long-coil system 13 inside motor housing 10. The magnet arrangement interacts here in a known manner with long-coil system 13 to produce a drive force. The length of armature 14 is substantially less than the length of long-coil system 13 or motor housing 10, and is roughly half the length of motor housing 10 in this embodiment. As shown in FIG. 4, a bumper element 16 is arranged at the end face of armature 14 on the base side in order to prevent a hard impact upon complete excursion of the linear drive.

Motor housing 10 is closed off at its opposite ends by covers 15 with a drive rod 17 fixedly connected to armature 14 extending at one end outwards through a housing cover 34. This drive rod 17 is fixed at its opposite end area to a plate-shaped drive element 18, which in principle can, of course, have any desired shape. Drive element 18 can constitute the driven element itself, or an element to be driven can be connected to drive element 18. To prevent a hard collision during a retraction of drive rod 17, buffer elements can be fixed on housing cover 34 and/or on drive element 18, for example.

Two guide rods 19, 20 arranged in parallel on either side of drive rod 17 are likewise fixed to drive element 18 and extend into guide channels 21 of base housing 12. They are guided there by means of ball bush guides 22, with other linear guides also being possible in principle.

The diameter, or cross section, of drive rod 17 is substantially smaller than that of guide rods 19, 20. In this embodiment, drive rod 17 has a cross section that is 15% of the cross section of guide rods 19, 20. The term “cross section” is understood to be the cross-sectional area enclosed by the circumferential line of the respective rod. In effect, drive rod 17 forms a solid-body articulation that renders an articulated bearing on drive element 18 unnecessary. The cross section of drive rod 17 can, of course, vary, but it should be less than 50% of the cross section of a guide rod.

As an optimal arrangement, the two guide rods 19, 20 are run on either side of the drive rod. Other arrangements are possible in principle, the number of guide rods 19, 20 also possibly being larger. For instance, four guide rods could be provided in an appropriate mechanical design.

For position measurement, a position measuring rod 23 is likewise fixed to drive element 18 and extends into an accommodation channel 24 in base housing 12. A position sensor 26 that cooperates with position measuring rod 23 is arranged in a sensor channel 25, arranged parallel to this accommodation channel 24. On the opposite side of accommodation channel 24, likewise running parallel to it, there is a groove-like channel 27, open to the outside, in which an additional position sensor 28 is guided to be movable in the longitudinal direction and is fixed in a desired measuring position. This position constitutes a reference position, with position sensor 28 being constructed as a magnetic field-sensitive sensor and interacting with the magnetic area of position measuring rod 23 or with a magnet element on this positioning measuring rod 23. In principle, several such position sensors 28 can be arranged in groove-like channel 27 for detecting several reference positions.

On the opposite side, position measuring rod 23 is magnetized in a strip pattern, wherein a strip-shaped element 29, which is in turn magnetized in a strip pattern and fixed in an appropriate longitudinal recess of position measuring rod 23, is provided in the present embodiment. This strip-shaped element 29 cooperates with first position sensor 26, the strip-shaped magnetizations each generating a sensor signal, and the sensor signals being counted upwards or downwards, depending on the direction of motion, in a counter device, not shown.

In a simpler embodiment, only position sensors 28 for detecting certain positions can be provided.

The continuous position detection by means of a strip-shaped magnetized element and the detection of reference positions can also be arranged separately. Thus, position measuring rod 23 may interact only with position sensor 26 for detecting the signals of strip-shaped elements 29, for instance, while at least one position sensor for determining position positions [sic] can be arranged in an additional position measuring rod, not shown, which plunges into an additional accommodation channel 30. Position sensor 28 can also be fixed in an additional groove-like channel 31 that is arranged in the area of accommodation channel 30.

Other known position measuring methods could of course also be used alternatively. Thus, for instance, position measuring rod 23 could bear a series of Hall sensors or other magnetic field-sensitive sensors that interact with the magnetic element on the housing, or such a series of magnetic field-sensitive sensors can be positioned in the housing, and sensor channel 25, for instance, can interact with a magnetic element on position measuring rod 23. In a conventional manner, battery-operated systems that operate with reduced accuracy and other functional limitations, but do not suffer any loss of position information in case of a power failure could be used. Such a battery-operated system cooperates with a precise incremental measuring system as was described for this embodiment. The fine-scale system supplies the position information for the controller, and the battery-operated one maintains the position-dependent counter state.

Motor housing 10 consists of a ferromagnetic material that serves as a magnetic return member for the magnet arrangement of linear motor 11 and simultaneously as a magnetic shielding that prevents magnetic fields from reaching the outside. This shielding prevents the position measuring device from being impaired by magnetic fields from linear motor 11, in order, thus, to attain a higher precision.

Base housing 12 has two cable channels 32, 33 running in the longitudinal direction, of which one cable channel 32 serves to accommodate the supply lines for linear motor 11, or long-coil system 13, and the other cable channel 33 for accommodating sensor lines, so that mutual shielding is achieved. It goes without saying that additional sensors such as temperature sensors and the like, not shown, can be provided. Transverse channels from cable channels 32, 33 to motor housing 10 or to position sensors 26, 28, for instance, can be molded or milled, in a manner not illustrated, into the end faces of base housing 12 facing drive element 18. Housing cover 34 then closes off the mouths of cable channels 32, 33 and the transverse channels.

Cable channels 32, 33 and any additional cable channels run together at an electrical connection point 35 on the upper side of the housing, wherein the lines are electrically connected there to a plug or some other connection device for connecting to an external control unit.

What is claimed is:

1. An electrical linear drive device with an electric linear motor held in a base housing and having a long-coil system arranged in a motor housing serving as a magnetic return member, wherein an armature that is substantially shorter than long-coil system and has a permanent magnet arrangement is movably guided inside motor housing and drives a drive element (via drive rod extending to the outside, with at least two guide rods connected to drive element and running in base housing, and with a position measuring rod connected to drive element and plunging, depending on its position, into base housing, which element is arranged parallel to and a distance away from drive rod and cooperates with at least one position sensor for position detection.

2. The electrical linear drive device according to claim 1, wherein the cross section of the drive rod is less than half the cross section of one of the guide rods.

3. The electrical linear drive device according to claim 1, wherein the guide rods are arranged on either side of the drive rod substantially symmetrically.

4. The electrical linear drive device according to claim 1, wherein the guide rods have ball bush guides in the base housing.

5. The electrical linear drive device according to claim 1, wherein the at least one position sensor is arranged in the area of the position measuring rod for sensing markers on the position measuring rod for position detection in or on the base housing.

6. The electrical linear drive device according to claim 5, wherein a plurality of markers is provided along the position measuring rod as digital counting markers and/or at least one position marker for detecting at least one reference position.

7. The electrical linear drive device according to claim 5, further comprising a position sensor for detecting counting markers, or at least one position sensor for detecting the at least one position marker.

8. The electrical linear drive device according to claim 7, wherein the two position sensors are arranged on either side of a plunge channel for position measuring rod.

9. The electrical linear drive device according to claim 7, wherein an inner channel and/or a groove-like channel open to the outside for accommodating the sensor is provided in base housing.

10. The electrical linear drive device according to claim 7, wherein the base housing has internal cable channels for accommodating sensor lines and/or supply and control lines for linear motor.

11. The electrical linear drive device according to claim 10, wherein the cable channels open into a connection point for an external line.

12. The electrical linear drive device according to claim 10, wherein the opening or running channels on an end face of the base housing are covered by a housing cover.

13. The electrical linear drive device according to claim 10 wherein the motor housing is constructed in tubular form with a circular cross section.

14. The electrical linear drive device according to claim 10, wherein the base housing is constructed substantially as a rectangular prism.
